(19) United States
(12) Patent Application Publication
(10) Pub. No.: US 2022/0053693 A1
(43) Pub. Date: Feb. 24, 2022

(54) GROUND PRESSURE FEEDBACK SENSOR SYSTEM FOR CONTROLLING HEADER FLOAT

(71) Applicant: CNH Industrial America LLC, New Holland, PA (US)

(72) Inventors: Ryan T. Gahres, Richland, PA (US); Jeffrey B. Fay, II, Oxford, PA (US); Albert Childs, Denver, PA (US); Jeffrey C. Trowbridge, Stevens, PA (US); Jeff Thomas, Gordonville, PA (US); Jethro Martin, Ephrata, PA (US); Cory Douglas Hunt, Millersville, PA (US); Joel T. Cook, Akron, PA (US)

(21) Appl. No.: 17/409,314

(22) Filed: Aug. 23, 2021

Related U.S. Application Data
(60) Provisional application No. 63/069,384, filed on Aug. 24, 2020.

(51) Int. Cl. A01D 41/14; A01D 41/127

(52) U.S. Cl. CPC A01D 41/141; A01D 41/127; A01D 41/145

(57) ABSTRACT

A method for dynamically operating a header float system of an agricultural vehicle having a header movably mounted to a frame of the agricultural vehicle by an actuator. The method includes: determining a target ground reaction force between the header and a ground surface located below the header, determining an actual ground reaction force between the header and the ground surface, comparing the actual ground reaction force to the target ground reaction force, and upon determining that the actual ground reaction force differs from the target ground reaction force by a predetermined amount, operating the actuator to reduce a difference in value between the actual ground reaction force and the target ground reaction force. An agricultural vehicle having a header operated as described above is also provided.

### BACKGROUND OF THE INVENTION

Various types of agricultural vehicles use headers to process crop materials. For example, windrowers (also known as swathers) are used to cut crop material and form it into windrows (a cut row or material) that is later processed, typically after drying, by other equipment. Similarly, combine harvesters use headers to process crop materials, which are conveyed into a crop processing system located on the chassis of the vehicle. In either case, it is often desirable to movably mount the header to the chassis of the vehicle to allow height adjustment and/or tilt adjustment. It is also often desirable to mount the header such that it can move to follow or “float” over undulating terrain. Similar capability is often desirable in multi-segment headers to allow an articulated portion of the header to adjust or float relative to an adjacent part of the header.

A typical self-propelled windrower has a header that is movably mounted to the vehicle chassis by hydraulic actuators. The hydraulic actuators comprise piston and cylinder assemblies that use hydraulic fluid to move the piston relative to the cylinder. The position of the header is controlled by changing the volume of fluid in the cylinder. Float is provided by including an accumulator in the hydraulic circuit. A typical accumulator is a reservoir that is fluidly connected to the hydraulic circuit, and contains a volume of pressurized gas. In use, as the header moves over undulating terrain, the gas can expand and contract to provide a spring-like resilience to the hydraulic circuit. Thus, the header is effectively suspended on an air spring.

It will be appreciated from the foregoing that the gas pressure dictates the spring force, and therefore controls the amount of force required to allow the header to float. The spring force can be adjusted by varying the state of a pressure reducing valve connected to the accumulator. For example, in one known system, a pressure reducing valve (“PRV”) is used to control the pressure. This device operates by using an electric current to set the PRV operating state. The operator can adjust the current to the PRV using a toggle switch or other controls. Such systems are functional, but can suffer from various problems that cause the actual floatation force to vary significantly for a given current setting. For example, variations in hydraulic oil temperature, hysteresis in the PRV, and changes in operating friction throughout the system, can all change the actual floatation force provided by the accumulator without any change to the input current to the PRV. Similar problems occur when the header changes weight during operation. This can happen by accumulating crop material and soil to increase in weight. Similarly, the weight of the header can reduce after initial calibration if crop material or soil on the header during calibration fall off or dry out during operation. Thus, an experienced operator must occasionally adjust the signal to the PRV to maintain the desired floatation force.

An example of a system for controlling the header position using pressurized hydraulic fluid is provided in U.S. Pat. No. 5,633,452, which is incorporated herein by reference. In this example, the header height is established by setting a pressure in hydraulic header lift cylinders, and float is provided by providing an accumulator in the hydraulic circuit. A pressure sensor is used to determine if the hydraulic pressure in the circuit drops below a minimum safe value, and automatically raises the pressure when this happens. This system relies on sensing the hydraulic pressure of the hydraulic circuit, which can lead to problems. For example, friction in the hydraulic cylinders (so-called “stiction”), as well as at other locations such as pivots, can cause force reactions that make the hydraulic pressure of the fluid inaccurate as a measure of the actual header height setting. For example, during efforts to lift the header, a sticking hydraulic cylinder can generate high hydraulic pressure, without a corresponding increase in header height. U.S. Pat. No. 7,168,226 and U.S. Publication No. 2006/0254239 also show systems for controlling a header, and these references are incorporated herein by reference.

The inventors have determined that the state of the art of header floatation system can still be improved.

This description of the background is provided to assist with an understanding of the following explanations of exemplary embodiments, and is not an admission that any or all of this background information is necessarily prior art.

### SUMMARY OF THE INVENTION

In one exemplary aspect, there is provided a method for dynamically operating a header float system of an agricultural vehicle having a header movably mounted to a frame of the agricultural vehicle by an actuator. The method includes: determining a target ground reaction force between the header and a ground surface located below the header; determining an actual ground reaction force between the header and the ground surface; comparing the actual ground reaction force to the target ground reaction force; and upon determining that the actual ground reaction force differs from the target ground reaction force by a predetermined amount, operating the actuator to reduce a difference in value between the actual ground reaction force and the target ground reaction force.

In some exemplary aspects, determining the target ground reaction force comprises: determining an identity of the header; determining a predetermined target ground reaction force associated with the identity of the header; and setting the target ground reaction force to equal the predetermined target ground reaction force.

In some exemplary aspects, determining the target ground reaction force comprises receiving a selection of an adjustable value for the target ground reaction force.

In some exemplary aspects, determining the target ground reaction force comprises: determining an identity of the header; determining a predetermined target ground reaction force associated with the identity of the header; receiving a selection of an adjustment value for the target ground reaction force; and setting the target ground reaction force based on the predetermined target ground reaction force and the adjustment value.

In some exemplary aspects, determining the actual ground reaction force comprises measuring a respective force in each of one or more support members extending between the header and the ground surface. The one or more support members may each comprise a skid shoe pivotally mounted to the header. Measuring the respective force in each of the one or more support members may comprise detecting a status of a load cell mounted between each of the one or more support members and the header.

In some exemplary aspects, the actuator comprises a hydraulic actuator, and operating the actuator to reduce a difference in value between the actual ground reaction force and the target ground reaction force comprises adjusting an operating pressure of the hydraulic actuator. Adjusting the operating pressure of the hydraulic actuator may comprise changing an output pressure of a pressure reducing valve operatively connected to the hydraulic actuator.

In some exemplary aspects, the header comprises a wing of a segmented header, and the frame comprises a center section of the segmented header; or the header comprises a windrower header, and the frame comprises a chassis of the agricultural vehicle.

In another exemplary aspect, there is provided an agricultural vehicle having a frame, a header movably mounted to the frame, an actuator configured to move the header relative to the frame, and a control system operatively connected to the actuator. The control system is configured to: determine a target ground reaction force between the header and a ground surface located below the header, determine an actual ground reaction force between the header and the ground surface, compare the actual ground reaction force to the target ground reaction force, and upon determining that the actual ground reaction force differs from the target ground reaction force by a predetermined amount, operate the actuator to reduce a difference in value between the actual ground reaction force and the target ground reaction force.

In some exemplary aspects, the control system is configured to communicate with an electrical system of the header to determine an identity of the header, and select the target ground reaction force based on the identity of the header.

In some exemplary aspects, the control system comprises a user interface configured to receive a selection of an adjustable value for the target ground reaction force.

In some exemplary aspects, the control system is configured to: communicate with an electrical system of the header to determine an identity of the header; identify a predetermined target ground reaction force based on the identity of the header; receive a selection of an adjustment value for the target ground reaction force from a user interface; and set the target ground reaction force based on the predetermined target ground reaction force and the adjustment value.

In some exemplary aspects, the header comprises one or more support members extending between the header and the ground surface. The one or more support members may each comprise a skid shoe pivotally mounted to the header. The control system may be configured to determine the actual ground reaction force between the header and the ground surface by detecting a status of a load cell mounted between each of the one or more support members and the header.

In some exemplary aspects, the actuator comprises a hydraulic actuator, and the control system is configured to operate the hydraulic actuator to reduce a difference in value between the actual ground reaction force and the target ground reaction force by adjusting an operating pressure of the hydraulic actuator. The control system may be operatively connected to a pressure reducing valve that is configured to adjust the operating pressure of the hydraulic actuator.

In some exemplary aspects, the header comprises a wing of a segmented header, and the frame comprises a center section of the segmented header; or the header comprises a windrower header, and the frame comprises a chassis of the agricultural vehicle. In other aspects, the header comprises a subframe of a header, and the frame comprises a main frame of the header.

### BRIEF DESCRIPTION OF THE DRAWINGS

Embodiments of inventions will now be described, strictly by way of example, with reference to the accompanying drawings, in which:

FIG. 1 is a side schematic view of an agricultural windrower configured for use with a header float control system.

FIG. 2 is an isometric bottom view of an exemplary header.

FIG. 3 is a cutaway isometric to view of portions of the header of FIG. 1.

FIG. 4 is a schematic illustration of an exemplary header float control system.

FIG. 5 is a flow chart illustrating an exemplary method for operating a header float control system.

FIG. 6 is a schematic illustration of a hydraulic system for controlling a header.

FIG. 7 is a schematic illustration of the hydraulic system of FIG. 1, shown in a different valve configuration.

FIG. 8 is a front schematic view of an agricultural vehicle configured for use with a header wing section float control system.

FIG. 9 is a side schematic view of an agricultural windrower configured for use with a header subframe float control system.

In the figures, like reference numerals refer to the same or similar elements.

### DETAILED DESCRIPTION OF THE DRAWINGS

The terms “crop” and “crop material” are used to describe any mixture of grain, seeds, straw, tailings, and the like. “Grain” or “seeds” refer to that part of the crop material which is threshed and separated from the discardable part of the crop material (e.g., straw and tailings), and includes grain in aggregate form such as an ear of corn. The portion of the crop material that generally is discarded or not used for food or growing purposes may be referred to as non-grain crop material, material other than grain (MOG) or straw.

Also the terms “forward,” “rearward,” “left,” and “right”, when used in connection with the agricultural harvester (e.g. combine) and/or components thereof are usually determined with reference to the direction of forward operative travel of the combine, but again, they should not be construed as limiting. The terms “longitudinal” and “transverse” are determined with reference to the fore-and-aft direction of the agricultural combine and are equally not to be construed as limiting.

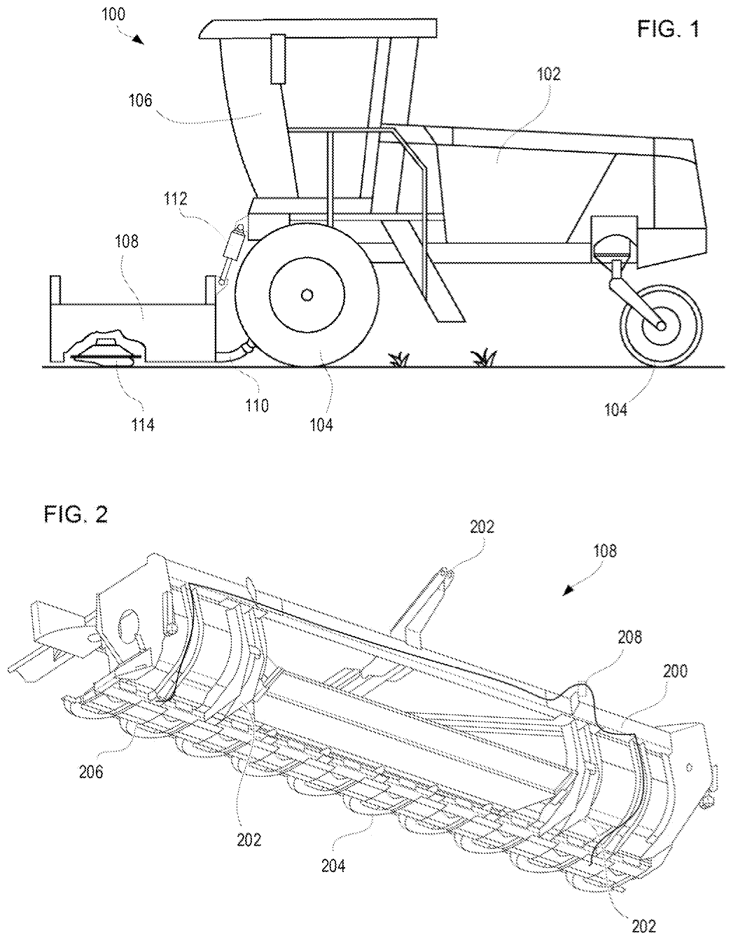

FIG. 1 shows an example of an agricultural vehicle 100 in the form of a self-propelled windrower. The vehicle 100 has a chassis 102 that is supported for movement on the ground by wheels 104 or the like, and one or more motors (not shown) are provided to power the wheels 104 and other systems. The vehicle 100 may have an operator's cab 106, and other features typical of a self-propelled windrower. A header 108 is movably mounted to the chassis 102, such as by being mounted on pivoting swing arms 110, four-bar linkages, linear slides, or the like. One or more actuators 112 are provided to control the position of the header 108 relative to the chassis 102. The actuators 112 typically comprise hydraulic actuators, such as telescoping piston/cylinder assemblies, but other actuators may be used (e.g., pneumatic or electric actuators). The header 108 includes one or more operating components, such as disc or sickle head cutters 114, that process the crop materials.

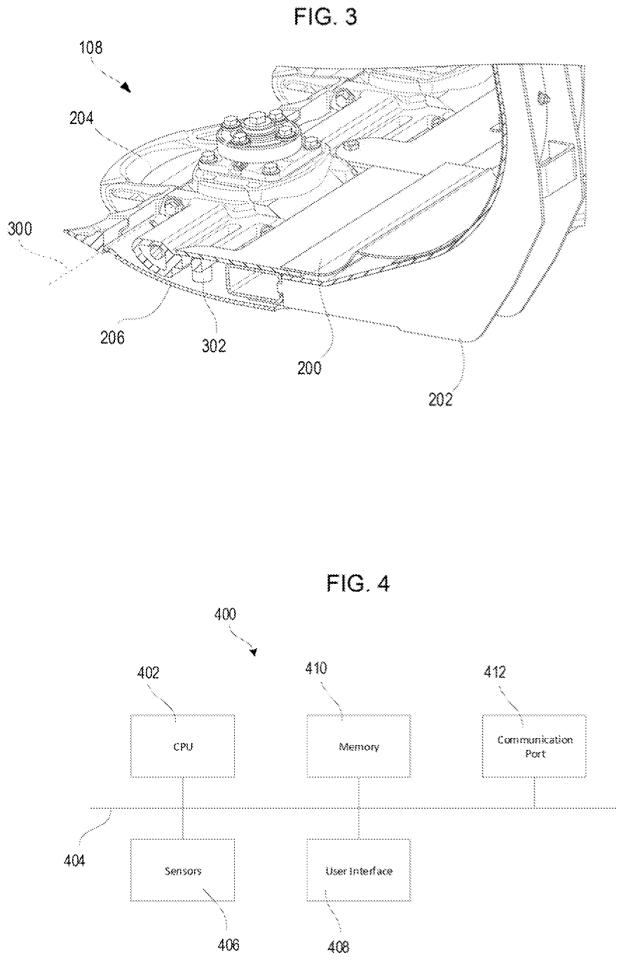

FIGS. 2 and 3 show an exemplary header 108 in more detail. The header 108 has a frame 200 having a plurality of mounting points 202 to which the actuator(s) 112, swing arms 110, or other suspension components are attached. The header 108 also includes operating components, such as crop cutters 114 (see FIG. 1), and associated parts such as rock guards 204, which typically are arrayed along the leading edge of the header frame 200.

Header support members 206, such as skid shoes (shown) or wheels, are arranged along the bottom of the header frame 200. The support members 206 may be mounted to the frame 200 by direct bolted connection or by pivots or the like. For example, each support member 206 may be pivotally mounted to rotate or flex about a respective pivot axis 300. The pivot axes 300 of the support members 206 may be collinear or offset from each other.

In some cases, at least one support member 206 is provided at each side of a lateral centerline of the header 108, to provide support at each end of the header 108. In some cases, however, such as when the header 108 is a wing section attached to a center section, a single support member 206 may be used. An example of such an embodiment is discussed below.

One or more of the support members 206 include an associated load cell 302 or load cells 302 that is/are positioned in a load path between the frame 200 and the support member 206. Each load cell 302 is configured to generate an output signal representative of a force applied to the load cell 302 as operating forces act on the support member 206 and frame 200. For example, the load cells 302 may comprise strain gauge-type or piezoelectric-type gauges that are calibrated to generate a voltage or current proportional to a strain—and thus the force—experienced by the sensor. Other force sensors may be used in other cases.

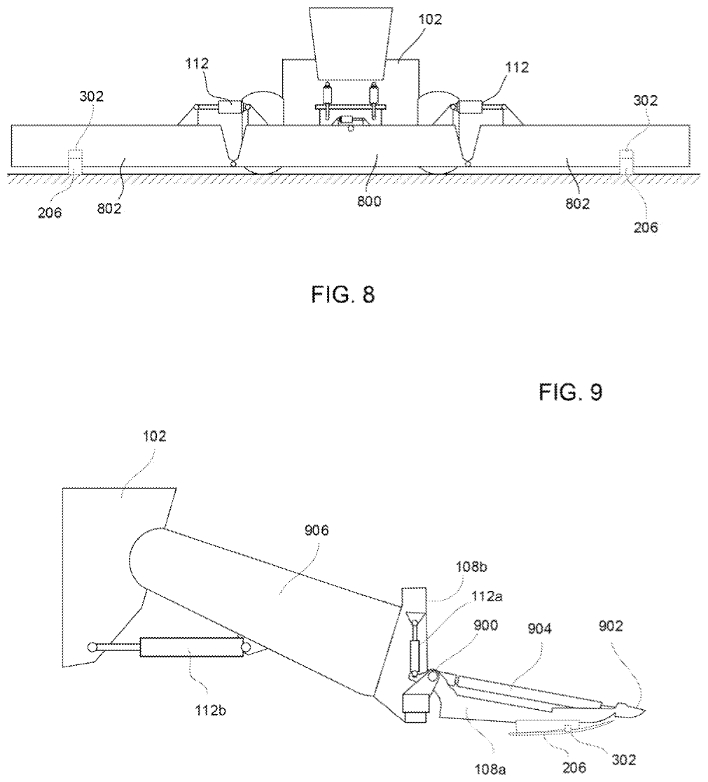

The support members 206 are positioned between the underlying ground surface and the remainder of the header 108 or the suspended portions thereof (see, e.g., the embodiments of FIGS. 8 and 9), and thus outputs of the load cells 302 collectively indicate the total weight of the header 108 or the suspended portion of the header that is being supported by the ground at any given time. The remainder of the header's weight will be supported by the vehicle chassis 102 by way of the actuators 112 and other header suspension components.

The load cells 302 may be electrically connected to a wiring harness for providing power to and return signals from the load cells 302. Other embodiments may use battery-powered systems to operate the load cells 302 and send wireless signals of the load cells' data output. The header 108 also may include an electrical terminal 208 that can be connected to an electrical control system, such as discussed below.

FIG. 4 is a block diagram of exemplary hardware and computing equipment that may be used as a control system 400 to control the float characteristics of the header 108. The control system 400 includes a central processing unit (CPU) 402, which is responsible for performing calculations and logic operations required to execute one or more computer programs or operations. The CPU 402 is connected via a data transmission bus 404, to sensors 406 (e.g., load cells 302), a user interface 408, and a memory 410. The user interface 408 may comprise any suitable device for providing user input to or output from the control system 400, such as toggle switches, dials, digital switches, touchscreen displays, and the like. The control system 400 also has a communication port 412 that may be operatively connected (wired or wirelessly) to the header's electrical terminal 208. One or more analog to digital conversion circuits may be provided to convert analog data from the sensors 406 to an appropriate digital signal for processing by the CPU 402, and signal conditioning circuits may be used to filter or perform other functions on the raw data, as known in the art.

The CPU 402, data transmission bus 404 and memory 406 may comprise any suitable computing device, such as an INTEL ATOM E3826 1.46 GHz Dual Core CPU or the like, being coupled to DDR3L 1066/1333 MHz SO-DIMM Socket SDRAM having a 4 GB memory capacity or other non-transitory memory (e.g., compact disk, digital disk, solid state drive, flash memory, memory card, USB drive, optical disc storage, etc.). The CPU 402 also may comprise a circuit on a chip, microprocessor, or other suitable computing device. The selection of an appropriate processing system and memory is a matter of routine practice and need not be discussed in greater detail herein. The control system 400 may be integrated into an existing vehicle control system, added as a new component, or be a self-contained system.

It is to be understood that operational steps performed by the control system 400 may be performed by the controller upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein is implemented in software code or instructions which are tangibly stored on a tangible computer readable medium. Upon loading and executing such software code or instructions by the controller, the controller may perform any of the functionality of the controller described herein, including any steps of the methods described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

The inventors have determined that the float performance of a header 108 can be enhanced by using force measurements indicative of the actual weight of the header 108 on the ground (i.e., the ground reaction force). Such force measurements provide feedback in a form that can eliminate errors associated with hydraulic pressure sensors, and that can be used to accurately and automatically adjust for changing operating conditions, such as changes in header weight and oil temperature.

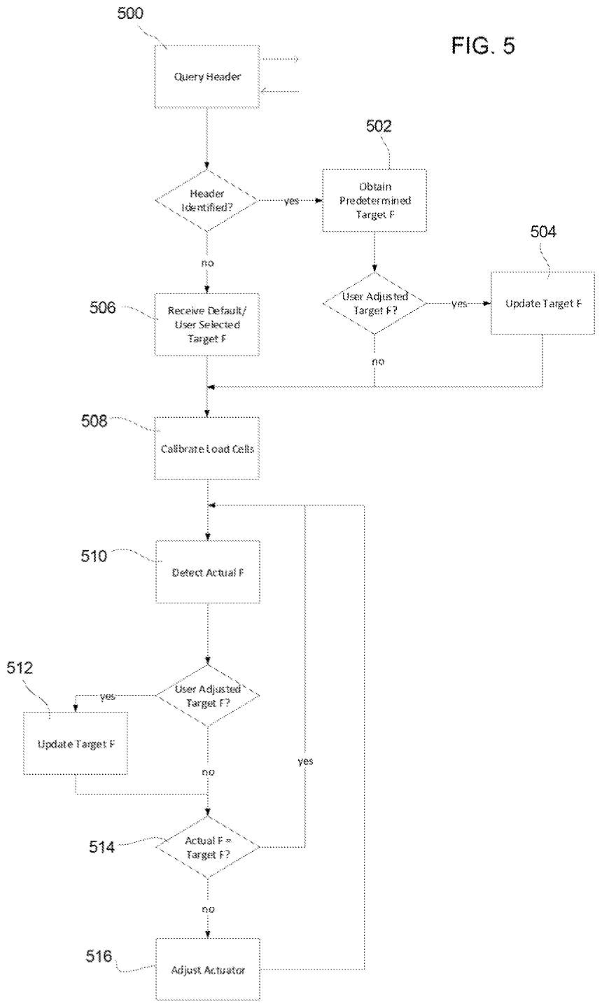

FIG. 5 illustrates an exemplary method for operating a header control system 400 to adjust the float characteristics of a header 108 based on measurements obtained by the load cells 302. The method has three main parts: identifying a target ground reaction force, comparing the actual ground reaction force with the target ground reaction force, and adjusting one or more operating parameters of the actuator system to reduce a difference between the target ground reaction force and the actual ground reaction force.

The target ground reaction force is the desired amount of force exerted between the header 108 (or the suspended portion, such as a wing section or subassembly, of the header) and the ground. This value may be a single value representing the total header weight (e.g., a total of x pounds force among all of the load cells 302), or it may be divided into target ground reaction forces at multiple locations along the header (e.g., x/2 pounds force at each of two load cells 302). Dividing the target value into multiple forces at different locations may have the benefit of helping to ensure that the weight of the header 108 is not concentrated at a single location. Dividing the target value into multiple forces also can be used to perform separate control feedback loops at different actuators associated with different load cells 302. The target ground reaction force also may vary depending on the particular load cell 302, such as when certain components and their associated load cells 302 are desired to carry more or less weight. The target ground reaction force also may be selected based on other factors, such as the position of the header or header subassembly relative to the vehicle chassis 102 or the rest of the header. For example, the target ground force might vary depending on the position of flex arms holding operating components (e.g., higher force allowed or desired at higher vertical elevations, or vice-versa). Such values can be set according to predetermined equations or using lookup tables, or modified by manual user adjustment. Other alternatives and variations will be apparent to persons of ordinary skill in the art in view of the present disclosure.

Identifying the target ground reaction force can be accomplished in various ways. At step 500 of the shown example, the control system 400 first attempts to detect and identify the header by querying the header electronics via the header's electrical terminal 208 or other communication path (e.g., wireless) with the header 108. Such query may comprise a signal sent to the header 108 to determine properties of the header (e.g., a particular number and/or type of load cells 302 indicative of a distinct type of header), or a signal sent to a processor or circuit in the header 108 that is configured to return a header identification code or signal. The query also may be sent to other operating systems of the vehicle 100, which may be programmed to have the identity of the header 108. The identity of the header 108 may be, for example, an indicator of a particular class of headers (e.g., windrower headers), type of header (e.g., windrower headers with a particular blade arrangement), or it may be a unique identifier of an individual header. The identity of the header also may indicate other variables, such as the particular size or width of the header. This may be useful to determine how many load cells 302 will be part of the control system, knowing an area over which the load is distributed for determining average ground pressure, and so on.

In step 502, if the control system is able to identify the header 108, it then obtains a predetermined target ground reaction force that is associated with the particular type of header 108. For example, the header's manufacturer may recommend operating a header having a particular construction at a certain default target ground reaction force. Upon identifying that the header is one of that particular type, the control system 400 can then automatically set the target ground reaction force as the predetermined target ground force value.

The control system 400 also may be configured to allow the operator to adjust the predetermined target ground reaction force, based on operating conditions or other factors. Thus, in step 504 the control system 400 can update the target ground reaction force if an operator adjustment is received (e.g., add or subtract a user-selected adjustment amount value, or replace the total value with the user-selected total value).

If the control system 400 is not able to identify the header 108, then the control system 400 uses a default value, or receives a user-selected adjustable value of the target ground reaction force from the user interface 408 (step 506).

In step 508, the control system 400 calibrates the load cells 302 by raising the header 108 out of contact with the ground. At this point, the load cells 302 are set to a zero-load value. The calibration step 508 also may be used to guide the operator to select a target ground reaction force, if no value is already selected. For example, when the operator moves the header 108 to contact the ground after calibration, the control system 400 may use the resting force at the end of the operator's lowering process as the target ground reaction force.

Beginning at step 510, the control system 400 performs a control loop during operation of the header 108 on the ground. At step 510, the control system 400 obtains output signals from the load cells 302 to determine the actual ground reaction force (either collectively, or as a function of particular load cells 302 or groups of load cells 302). The raw data from the load cells 302 may be processed in a variety of ways to remove noise, account for transient loads caused during operation, remove contributions caused by regular vibrations (e.g., cyclical vibrations caused by the cutters), smooth the data, and so on. The control system 400 also preferably includes, during the control loop, a step of determining whether the operator has adjusted the desired ground force target value and updating the ground force target value accordingly (step 512).

In step 514, the control system 400 compares the actual ground reaction force with the target ground reaction force, and determines whether they are within a predetermined amount of deviation—i.e., “equal.” It will be appreciated that the predetermined amount of deviation may be selected based on various factors, such as sensor accuracy, control system operating performance, and the like. For example, if a deviation of a certain amount of force is deemed insignificant, then the predetermined amount may be set as this amount of force, thus leading to adjustments being made only when the deviation is considered significant. Alternatively, the control system 400 may be programmed to consider any detectable difference in force to be above the predetermined amount of deviation, in which case the predetermined amount is equal to the smallest unit of measurement. Also, a default deviation (e.g., 50 pounds) may be programmed into the system, with subsequent user adjustment being possible (e.g., by raising or lowering the deviation threshold value before a change in operating state is initiated).

If it is determined in step 514 that the values are equal (i.e., within the predetermined amount), then the control loop returns to step 510. If the values are not equal, then the control loop proceeds to step 516, in which the control system 400 adjusts one or more operating parameters of the actuators 112 to reduce or eliminate the difference between the actual ground reaction force and the target ground reaction force. Any suitable control algorithm may be used, such as proportional control, proportional-integral-derivative (“PID”) control, or the like.

It will be appreciated that the foregoing method may be modified in various ways, or replaced by a different control method. For example, the header control system 400 may be operated by setting a target maximum ground force, and controlling the actuators 112 to maintain the measured ground force below the maximum value. This may be helpful, for example, to avoid “bulldozing” the soil in certain ground conditions, and to prevent potentially damaging overloads. Such a control process may be added to the foregoing process, or used as a separate process. Other alternatives and variations will be apparent to persons of ordinary skill in the art in view of the present disclosure.

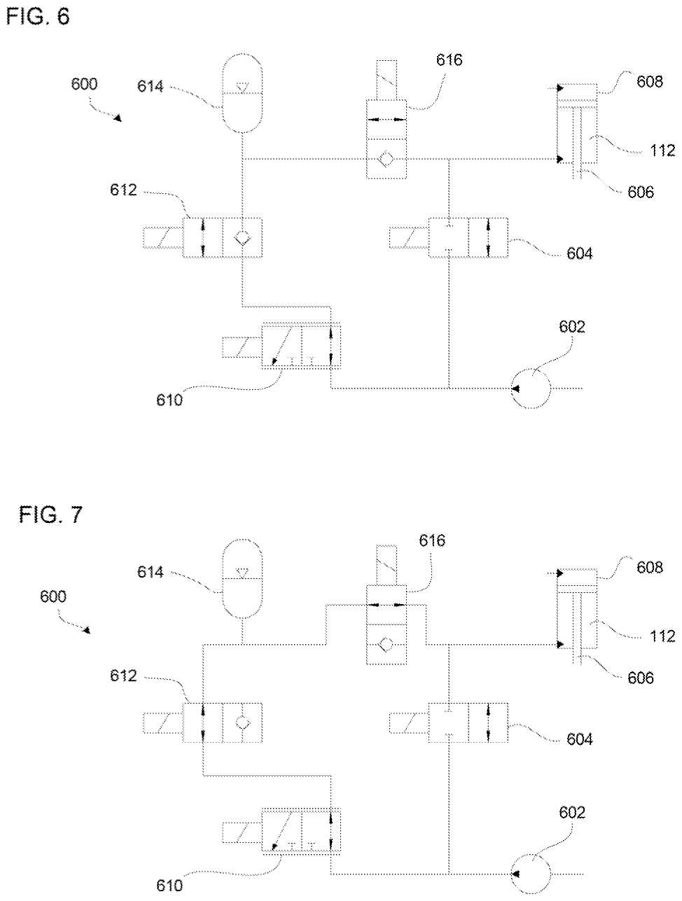

FIG. 6 illustrates an example of a hydraulic system 600 that may be used to control the header system to achieve uniform ground reaction forces as described above. The hydraulic system 600 generally includes an actuator 112 that is controlled by a source of pressurized hydraulic fluid such as a hydraulic pump 602 and control valves.

In this example, a position control valve 604 is connected between the actuator 112 and the pump 602, and operable to increase or decrease the static volume of hydraulic fluid in the actuator 112 cylinder. In the open position, the pump 602 directs fluid into the actuator 112 to retract the actuator piston 606 into the cylinder 608. The actuator 112 is connected between the chassis 102 and the header 108 such that retracting the piston 606 raises the header 108. Thus, the position control valve 604 may be used to set the operating height of the header 108. When the operating height is set, the position control valve 604 is closed (such as shown). The position control valve 604 also may include additional positions to vent hydraulic fluid from the cylinder 608 or direct fluid to the other side of the piston 606, in order to lower the header 108, or other position control valve systems may be used to lower the header 108 (e.g., a separate bleed valve located between the position control valve 604 and the actuator 112, etc.).

The hydraulic system 600 also includes an adjustable float circuit comprising an adjustable pressure reducing valve 610, a first float valve 612, an accumulator 614, and a second float valve 616. The pressure reducing valve 610 is connected to the pump 602, and can be adjusted to vary the magnitude of output pressure that is directed from via the pressure reducing valve 610 to the downstream remainder of the float circuit. Any suitable pressure reducing valve, such as a solenoid-operated or other electrically-controlled valve, may be used as the pressure reducing valve 610, as known in the art.

The first float valve 612 is located downstream of the pressure reducing valve 610, and is movable between an open position (FIG. 7) in which hydraulic fluid passes unimpeded in either direction, and a one-way position (FIG. 6) in which fluid can only pass downstream through the first float valve 612. Similarly, the second float valve 616 is located downstream of the first float valve 612, and configurable between an open position (FIG. 7) in which hydraulic fluid passes unimpeded in either direction, and a one-way position (FIG. 6) in which fluid can only pass downstream through the second float valve 616. The accumulator 614 is located in the hydraulic circuit joining the first float valve 612 to the second float valve 616. The accumulator 614 may comprise any suitable accumulator mechanism, such as a conventional adjustable gas-over-fluid accumulator having a sealed gas bladder located inside a hydraulic chamber.

The float circuit is operable to selectively connect the actuator 112 to pressurized hydraulic fluid to generate a force to bias the actuator 112 towards the retracted (i.e., lifted) position. In the position shown in FIG. 6, the first float valve 612 and second float valve 616 allow pressurized fluid to pass from the pump 602 to the actuator 112 to raise the header 108. However, reverse flow is not possible. Thus, external forces that raise the header 108 can pull hydraulic fluid from the pump 602 and/or accumulator 614 through the float valves 612, 616 into the actuator cylinder 608, but absent the opening of a separate vent the actuator 112 and header 108 cannot lower.

Moving the second float valve 616 to the open position allows reverse flow, and thus connects the actuator cylinder 608 to the accumulator 614. Thus, with the second float valve 616 open (as shown in FIG. 7), and the first float valve 612 closed (as in FIG. 6), the actuator 112 and header can move up and down by compressing or expanding the gas in the accumulator 614. However, if the pressure of this circuit drops below the input pressure of the pump 602 (as limited by the pressure reducing valve 610), more hydraulic fluid will pass through the first float valve to increase fluid volume in the accumulator 614 and/or actuator cylinder 608.

FIG. 7 shows the hydraulic circuit 600 with the first float valve 612 and the second float valve 616 in their respective open positions, to allow two-way flow through both valves. This configuration may be used temporarily to change the charge pressure of the accumulator 614, to thereby adjust the reaction load on the header 108 (e.g., increasing pressure in the accumulator 614 to reduce reaction forces, and vice versa).

The valve configuration in FIG. 7 also can be used continuously, to use the pressure reducing valve 610 to directly control the reaction forces at the actuator 112 in real time by continuously adjusting the output pressure of the pressure reducing valve 610. Specifically, pressurized fluid from the pump 602 is continuously connected to the actuator cylinder 608, and the pressure of this fluid generates a force that biases to the piston 606 towards the retracted position, and creates and upwards force at the header 108 to reduce the ground reaction force. The magnitude of this force is controlled by the pressure reducing valve 610. The output pressure of the pressure reducing valve 610 is controlled by a control system that uses force feedback at the header, such as described above in relation to FIG. 5, by modulating the magnitude of current applied to the pressure reducing valve 610. Thus, the pressure reducing valve 610 and hydraulic circuit 600 can be operated to provide a continuous or nearly continuous ground reaction force at the header 108 by adjusting the operating pressure of the actuator 112.

The exemplary hydraulic circuit 600 may be modified in various ways. For example, the hydraulic circuit 600, or one or more elements thereof, may be duplicated to provide separate control to a second actuator 112 (e.g., a separate actuator 112 operated by a separate float circuit but using a common pump 602 and hydraulic reservoir). Alternatively, a plurality of actuators 112 may be operatively driven by a single hydraulic circuit. Other alternatives and variations will be apparent to persons of ordinary skill in the art in view of the present disclosure.

It will also be appreciated that the foregoing systems and methods for controlling a header using measured ground reaction force may be applied to different types of headers or other equipment. Thus, the terms “header” and “frame” are used generically to refer to a part (the header) that is movably attached to another part (the frame). In the foregoing embodiment, the header 108 is attached to the chassis 102 of the vehicle (i.e., the frame), but in the example of FIG. 8 the header 108 is a portion of a header that is movably attached to another portion of the header. For example, FIG. 8 illustrates a segmented or “winged” header having a center section 800 and two wing sections 802. Each wing section 802 may include one or more support members 206 with respective load cells 302 configured to measure respective reaction forces between the support member 206 and the ground. Each wing section 802 also has an actuator 112 that is configured to raise the wing section 802 relative to the center section 800. The actuators 112 are separately or collectively controlled, such as described above, to maintain the ground reaction forces at the support members 206 at a continuous or nearly continuous value. In this example, each wing section 802 is a header, and the frame is the center section 800.

As another example, FIG. 9 illustrates a header subframe 108a that is attached to the header main frame 108b by a movable connection, such as a pivot 900. The subframe 108a may include various components, such as a cutterbar 902, draper belts 904, and skid shoes 206. One or more hydraulic actuators 112a connect the subframe 108a to the main frame 108b. In this case, the header subframe 108a is controlled, such as described above, to regulate the force of the subframe 108a on the ground via feedback from load cells 302 at the skid shoes 206. The header main frame 108b also may be movable relative to the chassis 102, such as by being attached to the chassis 102 by a movable feeder housing 906, as known in the art. This movable joint also may be operated by actuators 112b using a conventional control system, or a system as described herein to provide layered force control (e.g., one control to regulate force between the main frame 108b and the ground, and another control to regulate force between the subframe 108a and the ground). Other alternatives and variations will be apparent to persons of ordinary skill in the art in view of the present disclosure.

The present disclosure describes a number of inventive features and/or combinations of features that may be used alone or in combination with each other or in combination with other technologies. The embodiments described herein are all exemplary and are not intended to limit the scope of the claims. It will also be appreciated that the inventions described herein can be modified and adapted in various ways, and all such modifications and adaptations are intended to be included in the scope of this disclosure and the appended claims.

1. A method for dynamically operating a header float system of an agricultural vehicle having a header movably mounted to a frame by an actuator, the method comprising:
determining a target ground reaction force between the header and a ground surface located below the header;
determining an actual ground reaction force between the header and the ground surface;
comparing the actual ground reaction force to the target ground reaction force; and
upon determining that the actual ground reaction force differs from the target ground reaction force by a predetermined amount, operating the actuator to reduce a difference in value between the actual ground reaction force and the target ground reaction force.

2. The method of claim 1, wherein determining the target ground reaction force comprises:
determining an identity of the header;
determining a predetermined target ground reaction force associated with the identity of the header; and
setting the target ground reaction force to equal the predetermined target ground reaction force.

3. The method of claim 1, wherein determining the target ground reaction force comprises receiving a selection of an adjustable value for the target ground reaction force.

4. The method of claim 1, wherein determining the target ground reaction force comprises:
determining an identity of the header;
determining a predetermined target ground reaction force associated with the identity of the header;
receiving a selection of an adjustment value for the target ground reaction force; and
setting the target ground reaction force based on the predetermined target ground reaction force and the adjustment value.

5. The method of claim 1, wherein determining the actual ground reaction force comprises measuring a respective force in each of one or more support members extending between the header and the ground surface.

6. The method of claim 5, wherein the one or more support members each comprise a skid shoe pivotally mounted to the header.

7. The method of claim 5, wherein measuring the respective force in each of the one or more support members comprises detecting a status of a load cell mounted between each of the one or more support members and the header.

8. The method of claim 1, wherein the actuator comprises a hydraulic actuator, and operating the actuator to reduce a difference in value between the actual ground reaction force and the target ground reaction force comprises adjusting an operating pressure of the hydraulic actuator.

9. The method of claim 8, wherein adjusting the operating pressure of the hydraulic actuator comprises changing an output pressure of a pressure reducing valve operatively connected to the hydraulic actuator.

10. The method of claim 1, wherein:
the header comprises a wing of a segmented header, and the frame comprises a center section of the segmented header; or
the header comprises a windrower header, and the frame comprises a chassis of an agricultural vehicle; or
the header comprises a subframe of a header, and the frame comprises a main frame of the header.

11. An agricultural vehicle comprising:
a frame;
a header movably mounted to the frame;
an actuator configured to move the header relative to the frame; and
a control system operatively connected to the actuator and configured to:
determine a target ground reaction force between the header and a ground surface located below the header,
determine an actual ground reaction force between the header and the ground surface,
compare the actual ground reaction force to the target ground reaction force, and
upon determining that the actual ground reaction force differs from the target ground reaction force by a predetermined amount, operate the actuator to reduce a difference in value between the actual ground reaction force and the target ground reaction force.

12. The agricultural vehicle of claim 11, wherein the control system is configured to communicate with an electrical system of the header to determine an identity of the header, and select the target ground reaction force based on the identity of the header.

13. The agricultural vehicle of claim 11, wherein the control system comprises a user interface configured to receive a selection of an adjustable value for the target ground reaction force.

14. The agricultural vehicle of claim 11, wherein the control system is configured to:
communicate with an electrical system of the header to determine an identity of the header;
identify a predetermined target ground reaction force based on the identity of the header;
receive a selection of an adjustment value for the target ground reaction force from a user interface; and
set the target ground reaction force based on the predetermined target ground reaction force and the adjustment value.

15. The agricultural vehicle of claim 11, wherein the header comprises one or more support members extending between the header and the ground surface.

16. The agricultural vehicle of claim 15, wherein the one or more support members each comprise a skid shoe pivotally mounted to the header.

17. The agricultural vehicle of claim 15, wherein the control system is configured to determine the actual ground reaction force between the header and the ground surface by detecting a status of a load cell mounted between each of the one or more support members and the header.

18. The agricultural vehicle of claim 11, wherein the actuator comprises a hydraulic actuator, and the control system is configured to operate the hydraulic actuator to reduce a difference in value between the actual ground reaction force and the target ground reaction force by adjusting an operating pressure of the hydraulic actuator.

19. The agricultural vehicle of claim 18, wherein the control system is operatively connected to a pressure reducing valve that is configured to adjust the operating pressure of the hydraulic actuator.

20. The agricultural vehicle of claim 11, wherein:
the header comprises a wing of a segmented header, and the frame comprises a center section of the segmented header; or
the header comprises a windrower header, and the frame comprises a chassis of the agricultural vehicle; or
the header comprises a subframe of a header, and the frame comprises a main frame of the header.
